(19) United States
(12) Patent Application Publication
(10) Pub. No.: US 2008/0082533 A1
(43) Pub. Date: Apr. 3, 2008

(54) Persistent locks/resources for concurrency control

(76) Inventors: Tak Fung Wang, Redwood City, CA (US); Angelo Pruscino, Los Altos, CA (US); Wilson Wai Shun Chan, San Mateo, CA (US); Tolga Yurek, Foster City, CA (US)

Correspondence Address: HICKMAN PALERMO TRUONG & BECKER/ORACLE, 2055 GATEWAY PLACE, SUITE 550, SAN JOSE, CA, 95110-1083, US

(21) Appl. No.: 11/540,038

(22) Filed: Sep. 28, 2006

(51) Int. Cl. G06F 17/30

(52) U.S. Cl. 707/8

(57) ABSTRACT

The state of locks maintained in volatile memory by the master for the resources are preserved after termination of the master. The locks are preserved by storing persistent copies of the locks. The persistently stored copies of the locks are accessible to other nodes in a multi-node system of the master. Locks for which persistent copies are stored in this way are referred to as persistent locks. A persistent copy of data is a copy that is stored in a form of memory that is able to store the copy after the volatile memory storing the data is unable to do so.

### FIELD OF THE INVENTION

The present invention relates to database systems and more particularly to persistent lock/resources for concurrency control.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A multi-node computer system is made up of interconnected nodes that share access to resources. Typically, the nodes are interconnected via a network and share access, in varying degrees, to shared storage (e.g. shared access to a set of disk drives). The nodes in a multi-node computer system may be in the form of a group of computers (e.g. work stations, personal computers) that are interconnected via a network. Alternately, the nodes may be the nodes of a grid. A grid is composed of nodes in the form of server blades interconnected with other server blades on a rack.

The term resource herein refers to any resource used by a computer to which access between multiple processes is managed. Resources include units of memory, peripheral devices (e.g. printers, network cards), units of disk storage (e.g. a file, a data block), and data structures (a relational table, records of relational tables, a data block that holds records of a relational table). A shared resource is a resource shared and accessed by multiple nodes in a multi-node system.

Even though resources may be shared, many resources may not be used by more than one process at any given time. For example, most printers are unable to print more than one document at a time. Other resources, such as data blocks of a storage medium or tables stored on a storage medium, may be concurrently accessed in some ways (e.g. read) by multiple processes, but accessed in other ways (e.g. written to) by only one process at a time. Consequently, mechanisms have been developed which manage concurrent access to shared resources of a multi-node system.

Multi-Tiered Lock System

One such mechanism is referred to herein as a multi-tiered lock system. In a multi-tiered lock system, for a given shared resource, one node in a multi-node computer system is the “master” of the resource and responsible for managing access to the shared resource. Shared resources for which a node is master are referred to as shared resources mastered by the node or, for convenience of expression, as being the shared resources of the master.

The master globally manages concurrent access to a shared resource and maintains a global view of concurrent access to shared nodes. Access by processes in a multi-node system, whether the process is executing on the master or another node within the system, is controlled by the master of the resource. To gain access to a resource, a request must be made to the master of the resource, which may grant or deny the request. Processes on a node that is not the master (i.e. a “remote node”) may not individually be granted access to a resource by a master node. Rather, a remote node is granted access to a resource, and once granted, the process on the slave may access the resource.

A master node uses locks to manage access rights (“rights”) to a resource. A lock is a data structure that indicates whether a particular entity has requested, been granted and holds a certain right to a resource. When a request for the right represented by a lock has been granted, the lock itself is referred to as being granted. Until the lock is relinquished, the lock is referred as being held.

Lock Types

There are many types of locks. For a given resource, a “shared lock” represents a right to share access to the resource. A shared lock may be concurrently granted to multiple processes, allowing them the right to share a form of access (e.g. read access). An “exclusive lock” may only be concurrently granted to one process. Once granted, the lock prevents this type and other types of locks from being granted for the resource. While an exclusive lock is held for a resource, the resource is referred to as being exclusively locked.

Due to the various permissions and guarantees associated with these locks, certain combinations of locks are not allowed to be concurrently granted. For example, if a process owns an exclusive lock on a resource, then no other process can be granted an exclusive lock or a shared lock. If a process owns a shared lock, then other processes may be granted shared locks but may not be granted an exclusive lock. Locks which cannot be combined are referred to herein as being incompatible or conflicting.

Volatile Storage of Locks Leads to Excessive Recovery Processing

The locks are stored in a computer's volatile memory. Hence, the lock ceases to exist and dies when the master's memory is terminated. This is problematic for multi-tiered lock management systems when volatile memory termination is unplanned.

When a node fails, recovery procedures need to be performed for shared resources exclusively locked and possibly modified by the node. For a shared resource not mastered by the failed node, the surviving master node knows over which shared resources the failed node held locks and the state of those locks. However, the states of locks over resources mastered by the failed node itself are unknown to other nodes. In fact, the state of the master's shared resources may be unknown. These conditions cause unnecessary recovery processing of shared resourced mastered by the failed master.

For example, a master in a multi-node system holds an exclusive lock over shared data blocks. None of the other nodes in the multi-node system know or have data indicating that the master holds these exclusive locks. When the master fails, the other nodes do not know which of the master's data blocks were exclusively locked by the master. In fact, unless another node held a shared lock on a master's data block, the other nodes do not know whether or not the master had held an exclusive lock for the data block. It is possible that the master did not hold any exclusive lock over the data block; it is also possible that the master held an exclusive and has made changes to the data block.

As a safeguard, when a master fails, it is assumed, that all the master data blocks were exclusively locked and modified by the master. All the master's data blocks are exclusively locked and recovery procedures performed on all of them.

Based on the foregoing, it is clearly desirable to provide a mechanism that reduces the amount of recovery processing that must performed when a master fails.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram depicting a method for managing concurrency control for shared lock/resources according to an embodiment of the present invention.

FIG. 2 is a diagram of computer system that may be used in an implementation of an embodiment of the present invention.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Described herein are techniques for preserving the state of locks maintained in volatile memory by the master for the resources after termination of the master. The locks are preserved by storing persistent copies of the locks. The persistently stored copies of the locks are accessible to other nodes in a multi-node system of the master. The copy of the lock does not have to be an exact replica of a lock, but may contain or represent a portion of the lock, and may contain additional information. Locks for which persistent copies are stored in this way are referred to as persistent locks.

A persistent copy of data is a copy that is stored in a form of memory that is able to store the copy after the volatile memory storing the data is unable to do so. Examples of such memory include disk storage and the volatile memory of another computer that could survive a malfunction and failure of the computer whose volatile memory stores the data.

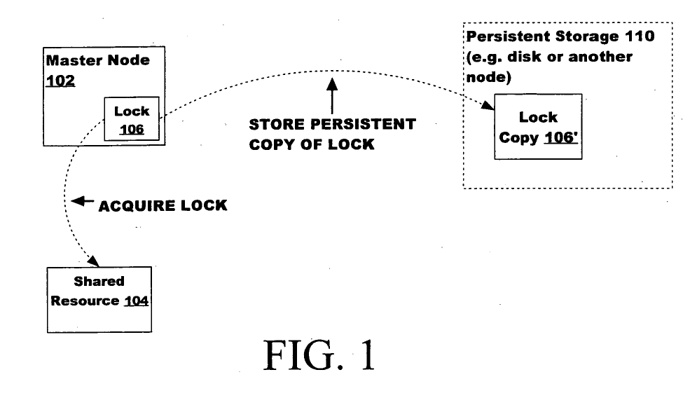

FIG. 1 illustrates an embodiment of the invention in which a master node in a multi-node system stores a persistent copy of a lock. In FIG. 1, node 102 is the master node for shared resource 104. In response to master node 102 acquiring a lock 106 on shared resource 104, a persistent copy of lock 106, lock copy 106′, is created and then stored in persistent storage 110. Lock copy 106 is maintained for at least the duration of lock 106.

The persistent storage 110 may be the volatile memory of another node in the multi-node system. In another embodiment of the invention, an additional persistent copy of lock 106 is stored and maintained in the volatile memories of more than one node in the multi-node system. This approach provides some additional reliability because a persistent copy is more likely to survive a failure involving multiple nodes.

In yet another embodiment of the invention, a copy of a lock is stored in non-volatile memory, for example, on a shared disk. A shared disk can be accessed directly by all nodes in a multi-node system rather than having to be accessed via another node, that is, all nodes may access data on the shared disk without first transferring the data to another node. This approach ensures persistency because the shared nonvolatile memory may not be affected by the termination of any node.

Persistence reduces recovery processing. Rather than locking all of failed master's resources, the only resources for which locks need to be acquired and recovery procedures performed are those resources for which there is a persistent copy of a lock held by the failed master at the time the master failed.

Fail-Over Processing of Transactions in a Database System

Lock persistence can also facilitate transaction failover processing, in which a surviving node (“recovery node”) in a multi-node database system finishes an uncompleted transactions that was being executed by a failed node. The uncompleted transaction is executed as a “fail-over transaction” on the surviving node. From the persistent copies of locks held by the failed node when it failed, the recovery node is able determine which resources needed to be locked in order to continue executing the transaction in a way that avoids re-performing work that was already performed by the failed node before the failure. Without such information, the recovery node needs to rollback the database to a transaction consistent state possessed prior to the node failure and then continue fail-over processing of transactions from that point. (In a transaction consistent state, a database reflects all the changes made by transactions which are committed and none of the changes made by transactions which are not committed.) Using these persistent copies, the recovery node is able obtain locks held for a fail-over transaction without having to contend with other nodes acquiring a conflicting lock.

In addition, information about the state of a transaction may be stored in a persistent copy of locks acquired for the transaction (“transaction locks”). This information may be useful for allowing transaction fail-over processing to be performed more efficiently.

### Hardware Overview

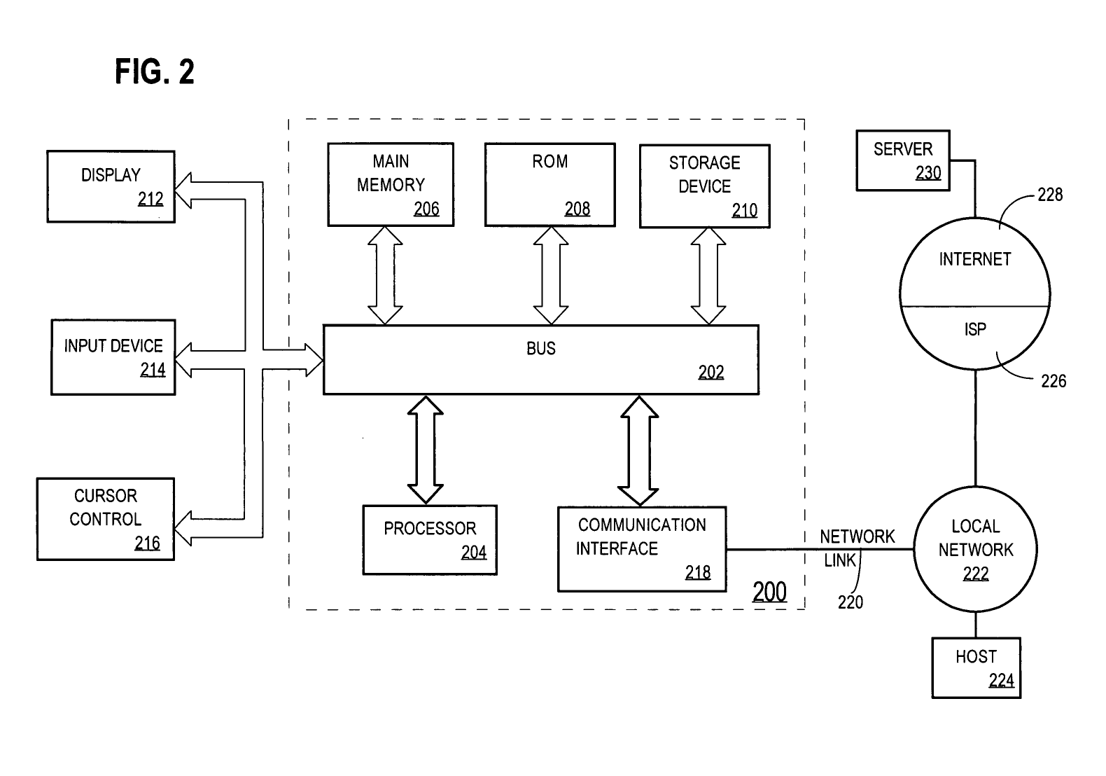

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 200, various machine-readable media are involved, for example, in providing instructions to processor 204 for execution. Such a medium may take many forms, including but not limited to, non-volatile media, volatile media, and transmission media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
a first node in a multi-node system acquiring a lock on a shared resource that may be accessed by other nodes in said multi-node system; and
in response to acquiring said shared resource, storing a persistent copy of said lock.

2. A method as recited in claim 1, wherein storing a persistent copy includes storing the persistent copy in non-volatile memory.

3. A method as recited in claim 2, wherein storing the persistent copy in non-volatile memory includes storing said persistent copy on a shared disk.

4. A method as recited in claim 1, wherein storing a persistent copy includes storing the persistent copy in the volatile memory of a certain set of one or more nodes.

5. A method as recited in claim 1, wherein the certain set includes a plurality of nodes.

6. The method of claim 1, the method further including a second node in said multi-node system reading said persistent copy to determine on which resources the first node held a lock.

7. The method of claim 6, wherein the first node is the master of said resource.

8. The method of claim 1, wherein the lock is acquired for a transaction, wherein the steps further include storing information regarding the state of the transaction in said lock.

9. A method, comprising the steps of:
a master node in a multi-node system managing access by one or more other nodes in said multi-node system to certain shared resources over which said master node is the master;
in a volatile memory of said master node, said master node storing said certain locks held by said master on said mastered shared resources; and
said master node maintaining persistent copies of said certain locks.

10. The method of claim 1, wherein the steps further include performing recovery procedures in response to detecting that said first node failed, wherein the step of performing recovery procedures includes a second node determining which of said shared resources to lock based on said persistent copies.

11. A computer-readable medium carrying one or more sequences of instructions which, when executed by one or more processors, causes the one or more processors to perform the method recited in claim 1.

12. A computer-readable medium carrying one or more sequences of instructions which, when executed by one or more processors, causes the one or more processors to perform the method recited in claim 2.

13. A computer-readable medium carrying one or more sequences of instructions which, when executed by one or more processors, causes the one or more processors to perform the method recited in claim 3.

14. A computer-readable medium carrying one or more sequences of instructions which, when executed by one or more processors, causes the one or more processors to perform the method recited in claim 4.

15. A computer-readable medium carrying one or more sequences of instructions which, when executed by one or more processors, causes the one or more processors to perform the method recited in claim 5.

16. A computer-readable medium carrying one or more sequences of instructions which, when executed by one or more processors, causes the one or more processors to perform the method recited in claim 6.

17. A computer-readable medium carrying one or more sequences of instructions which, when executed by one or more processors, causes the one or more processors to perform the method recited in claim 7.

18. A computer-readable medium carrying one or more sequences of instructions which, when executed by one or more processors, causes the one or more processors to perform the method recited in claim 8.

19. A computer-readable medium carrying one or more sequences of instructions which, when executed by one or more processors, causes the one or more processors to perform the method recited in claim 9.

20. A computer-readable medium carrying one or more sequences of instructions which, when executed by one or more processors, causes the one or more processors to perform the method recited in claim 10.
